(19) United States
(12) Patent Application Publication
(10) Pub. No.: US 2015/0032846 A1
(43) Pub. Date: Jan. 29, 2015

(54) METHODS, APPARATUS AND SYSTEMS FOR MOBILE CLOUD BURSTING

(71) Applicant: INTERDIGITAL PATENT HOLDINGS, INC., Wilmington, DE (US)

(72) Inventors: Serhad Doken, Chester Springs, PA (US); Shamim Akbar Rahman, Cote St. Luc (CA)

(73) Assignee: INTERDIGITAL PATENT HOLDINGS, INC., Wilmington, DE (US)

(21) Appl. No.: 14/380,487

(22) PCT Filed: Feb. 22, 2013
(86) PCT No.: PCT/US13/27238

§ 371 Date: Aug. 22, 2014

Related U.S. Application Data
(60) Provisional application No. 61/603,218, filed on Feb. 24, 2012.

(51) Int. Cl. H04L 29/08

(52) U.S. Cl. CPC H04L 67/32; H04L 67/141
USPC 709/217

(57) ABSTRACT

Systems, methods, and instrumentalities are provided to implement management of a mobile network computing resources (MNCRs) in, e.g., a core network entity of a mobile network. The core network (CN) entity may detect a condition related to the MNCR. The condition may be indicative of, for example, an overload of a computing resource in the CN entity of the mobile network. Based on the detected condition, the CN entity may generate a cloud computing resource (CCR) request. The CN entity may transmit the CCR request. The CN entity may generate a provisioning request. The CN entity may redirect a service request to the CCR. The CN entity may transfer one or more sessions to the CCR. If a condition detected at the CN entity is a security threat, the CN entity may transfer the sessions to a CCR.

### CROSS REFERENCE TO RELATED APPLICATIONS

This application claims the benefit of U.S. Provisional Patent Application No. 61/603,218, filed Feb. 24, 2012, the contents of which are hereby incorporated by reference herein.

### BACKGROUND

Cloud Computing has emerged as a technology that provides a variety of computing services that may be flexible, scalable, secure, etc. Cloud computing may provide on-demand services over the internet. Various public and private clouds may provide a range of services, including, for example, SaaS (Software as a Service), PaaS (Platform as a Service), and IaaS (Infrastructure as a Service). As an implementation of Saas, for example, an application server may be hosted remotely on the internet, as opposed to locally. As an implementation of PaaS, computing environments for development of user software may be hosted remotely and accessed on-demand by the user, for example, for remote SW development. As an implementation of IaaS, computing infrastructure (e.g., storage, servers, etc.) may be hosted remotely and accessed by the user on demand. Internet cloud computing may be oriented towards fixed infrastructure and enterprise related features such as applications, operating systems, storage, etc.

In enterprise networks, when the resources running the enterprise related features are exhausted or are unavailable, the feature may expand into the external public cloud. Existing technology allowing such expansion may be limited to enterprise networks and based on proprietary and/or limited implementations, and therefore inadequate.

### SUMMARY

Systems, methods, and instrumentalities are provided to implement management of a mobile network computing resources (MNCRs) in, e.g., a core network entity of a mobile network. The core network (CN) entity may detect a condition related to the MNCR. The MNCR may be part of a private mobile network operated by a network operator. The condition may be indicative of, for example, an overload of a computing resource in the CN entity of the mobile network or a service running inside a walled garden of a mobile network. For example, the condition may be an overload in a content data network (CDN), an overload in an IP Multimedia System (IMS) server, a denial of service (DoS) attack, etc.

Based on the detected condition, the CN entity may generate a cloud computing resource (CCR) request. The CCR may be part of cloud servers (e.g., third party servers). The CN entity may transmit the CCR request. For example, the CCR request may be transmitted via a tunnel (e.g., a secured IP tunnel). The CCR request may be sent, for example using hypertext transfer protocol (HTTP), via a gateway node.

The CN entity may generate a provisioning request, wherein the provisioning request may comprise an instruction to configure a CCR. The CN entity may transmit the provisioning request. For example, the provisioning request may be transmitted via a tunnel (e.g., a secured IP tunnel). The provisioning request may be sent using hypertext transfer protocol (HTTP), via the gateway node.

The CN entity may redirect a service request to the CCR. The CN entity may transfer one or more sessions to the CCR. If a condition detected at the CN entity is a security threat, the CN entity may transfer the sessions to a CCR and may shutdown or deactivate itself.

### BRIEF DESCRIPTION OF THE DRAWINGS

A more detailed understanding may be had from the following description, given by way of example in conjunction with the accompanying drawings.

FIG. 1A is a system diagram of an example communications system in which one or more disclosed embodiments may be implemented.

FIG. 1B is a system diagram of an example wireless transmit/receive unit (WTRU) that may be used within the communications system illustrated in FIG. 1A.

FIG. 1C is a system diagram of an example radio access network and an example core network that may be used within the communications system illustrated in FIG. 1A.

FIG. 1D is a system diagram of another example radio access network and another example core network that may be used within the communications system illustrated in FIG. 1A.

FIG. 1E is a system diagram of another example radio access network and another example core network that may be used within the communications system illustrated in FIG. 1A.

FIG. 2 illustrates an exemplary system diagram of a mobile network.

FIG. 3 illustrates an exemplary system diagram of mobile cloud architecture with two core networks (CNs) sharing a radio access network (RAN).

FIG. 4 illustrates an exemplary system diagram of mobile cloud architecture with a CN connected to a dedicated RAN.

FIG. 5 illustrates an exemplary system diagram of an interconnection scheme for a global mobile cloud.

FIG. 6 illustrates an exemplary system diagram of a mobile network architecture enabling a service provider to utilize a bulk portion of the mobile network capacity.

FIG. 7 illustrates an exemplary system diagram of a hybrid mobile cloud network.

FIG. 8 illustrates an exemplary system diagram of an interconnection scheme for a hybrid mobile network of, e.g., FIG. 7.

FIG. 9 illustrates an exemplary system diagram of a mobile network cloud bursting with a CN entity running an IMS application.

FIG. 9A illustrates an exemplary flow chart for performing the mobile cloud bursting of an IP multimedia service (IMS) application experiencing overload.

FIG. 10 illustrates an exemplary system diagram of a mobile network cloud bursting running an IMS application.

FIG. 10A illustrates an exemplary flow chart for performing the mobile cloud bursting to handle a DoS attack of an IMS application.

FIG. 11 illustrates an exemplary system diagram of a mobile network cloud with, e.g., a Content Distribution Network (CDN) running on a core network.

FIG. 11A illustrates an exemplary flow chart for performing the mobile cloud bursting to handle a CDN overload.

FIG. 12 illustrates an exemplary system diagram of a LTE based mobile network cloud bursting.

### DETAILED DESCRIPTION

A detailed description of illustrative embodiments will now be described with reference to the various figures. Although this description provides a detailed example of possible implementations, it should be noted that the details are intended to be exemplary and in no way limit the scope of the application. In addition, the figures may illustrate flow charts, which are meant to be exemplary. Other embodiments may be used. The order of the messages may be varied where appropriate. Messages may be omitted if not needed, and, additional flows may be added.

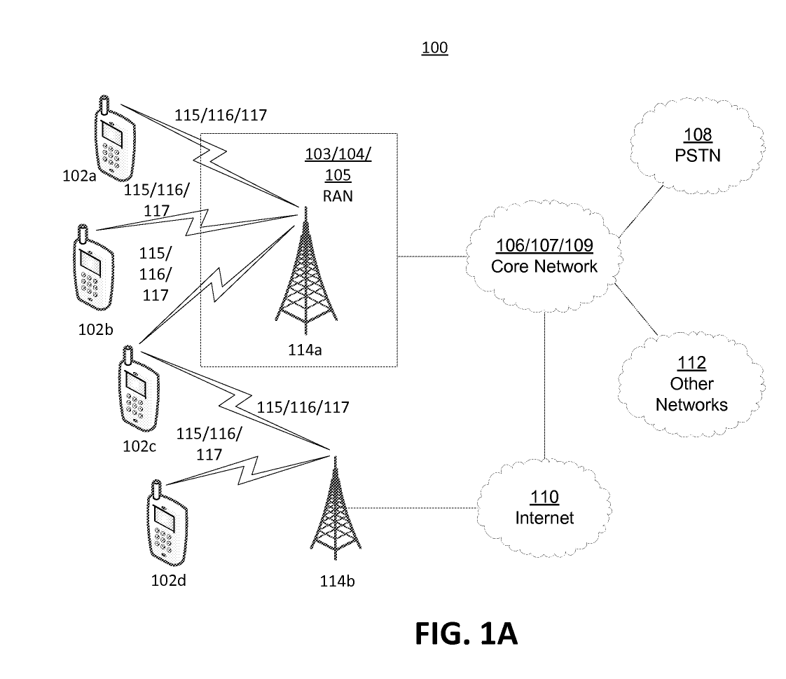

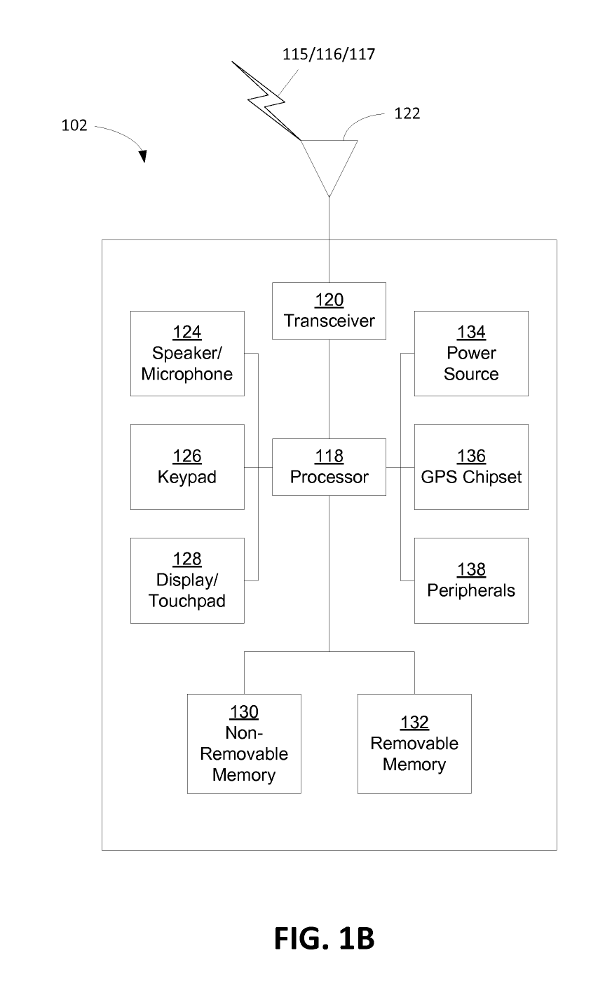

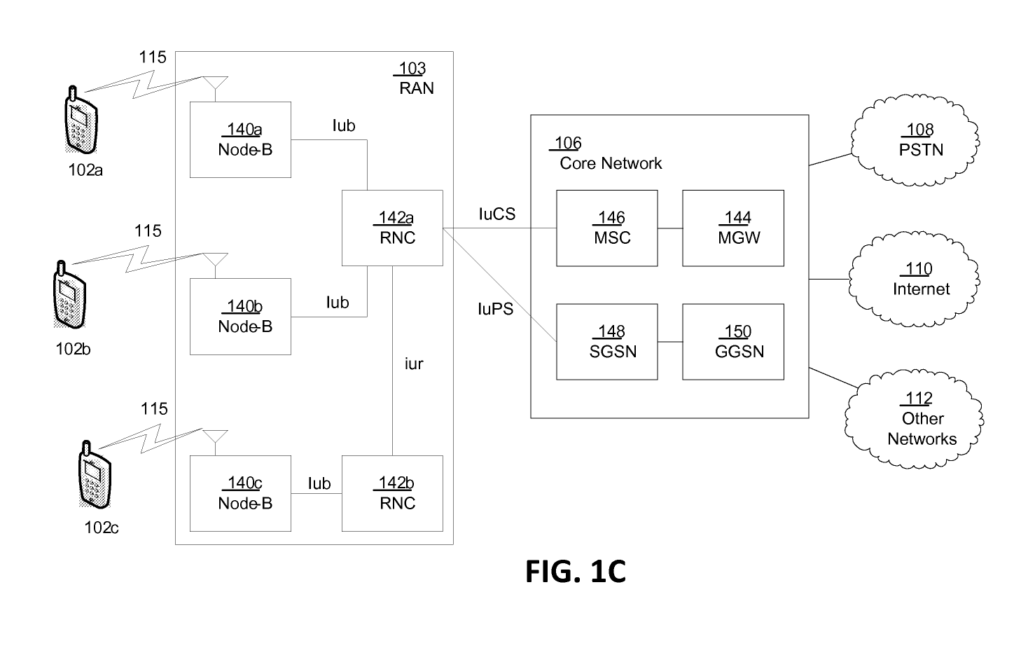

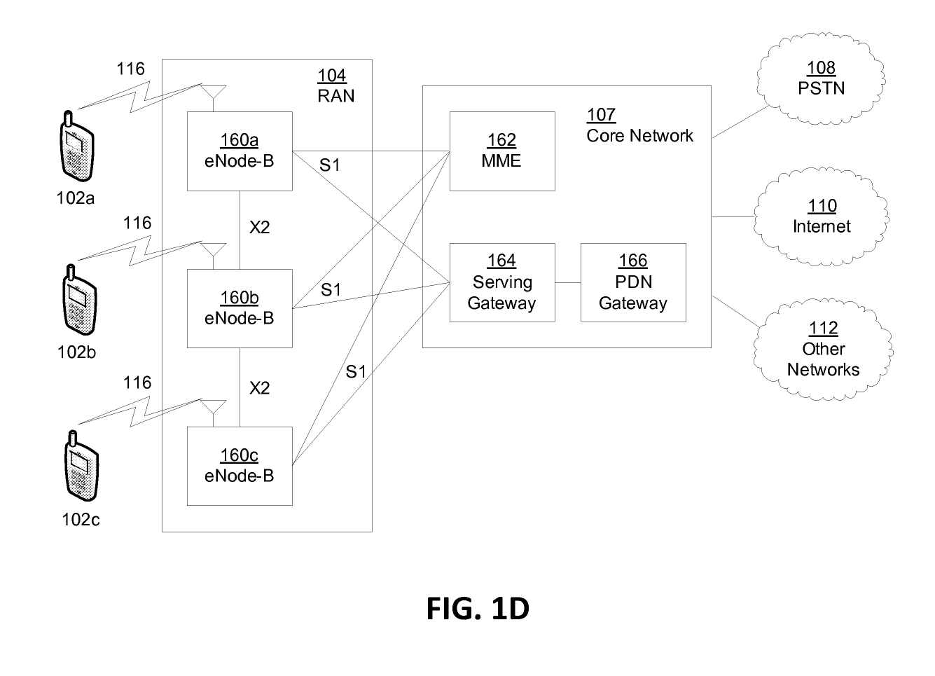

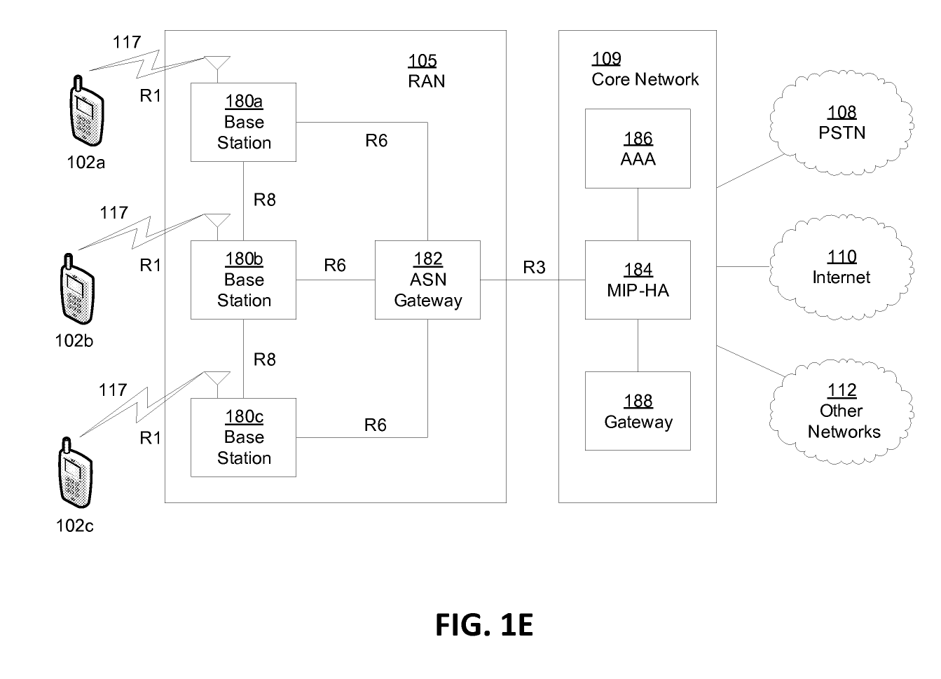

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, and/or 102d (which generally or collectively may be referred to as WTRU 102), a radio access network (RAN) 103/104/105, a core network 106/107/109, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (WTRU), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106/107/109, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 115/116/117, which may be any suitable wireless communication link (e.g., radio frequency (RF), microwave, infrared (IR), ultraviolet (UV), visible light, etc.). The air interface 115/116/117 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 115/116/117 using Long Term Evolution (LTE) and/or LTE-Advanced (LTE-A).

In an embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1x, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet an embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106/107/109.

The RAN 103/104/105 may be in communication with the core network 106/107/109, which may be any type of network configured to provide voice, data, applications, and/or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication. Although not shown in FIG. 1A, it will be appreciated that the RAN 103/104/105 and/or the core network 106/107/109 may be in direct or indirect communication with other RANs that employ the same RAT as the RAN 103/104/105 or a different RAT. For example, in addition to being connected to the RAN 103/104/105, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 1B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet an embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in an embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In an embodiment, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 103 and the core network 106 according to an embodiment. As noted above, the RAN 103 may employ a UTRA radio technology to communicate with the WTRUs 102a, 102b, 102c over the air interface 115. The RAN 103 may also be in communication with the core network 106. As shown in FIG. 1C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an embodiment.

As shown in FIG. 1C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 1D is a system diagram of the RAN 104 and the core network 107 according to an embodiment. As noted above, the RAN 104 may employ an E-UTRA radio technology to communicate with the WTRUs 102a, 102b, 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink and/or downlink, and the like. As shown in FIG. 1D, the eNode-Bs 160a, 160b, 160c may communicate with one another over an X2 interface.

The core network 107 shown in FIG. 1D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired or wireless networks that are owned and/or operated by other service providers.

FIG. 1E is a system diagram of the RAN 105 and the core network 109 according to an embodiment. The RAN 105 may be an access service network (ASN) that employs IEEE 802.16 radio technology to communicate with the WTRUs 102a, 102b, 102c over the air interface 117. As will be further discussed below, the communication links between the different functional entities of the WTRUs 102a, 102b, 102c, the RAN 105, and the core network 109 may be defined as reference points.

As shown in FIG. 1E, the RAN 105 may include base stations 180a, 180b, 180c, and an ASN gateway 182, though it will be appreciated that the RAN 105 may include any number of base stations and ASN gateways while remaining consistent with an embodiment. The base stations 180a, 180b, 180c may each be associated with a particular cell in the RAN 105 and may include one or more transceivers for communicating with the WTRUs 102a, 102b, 102c over the air interface 117. In an embodiment, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 1E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 1E, it will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks.

Systems, methods, and instrumentalities are provided to implement various architectures of a mobile cloud network. One or more of the mobile core network (CN) nodes (e.g., CN entities) may be moved out of a green walled network and integrated into the open Internet. A node of the mobile cloud network (e.g., the HLRs, SGSNs, etc.) may be virtualized. Systems methods, and instrumentalities provided to implement mobile cloud bursting, wherein a mobile network may detect a condition associated with the mobile network computing resource (MNCR) (e.g., MNCR of the core network of the mobile network) and request computing resources from an network external to the mobile network, e.g., cloud computing resources (CCRs).

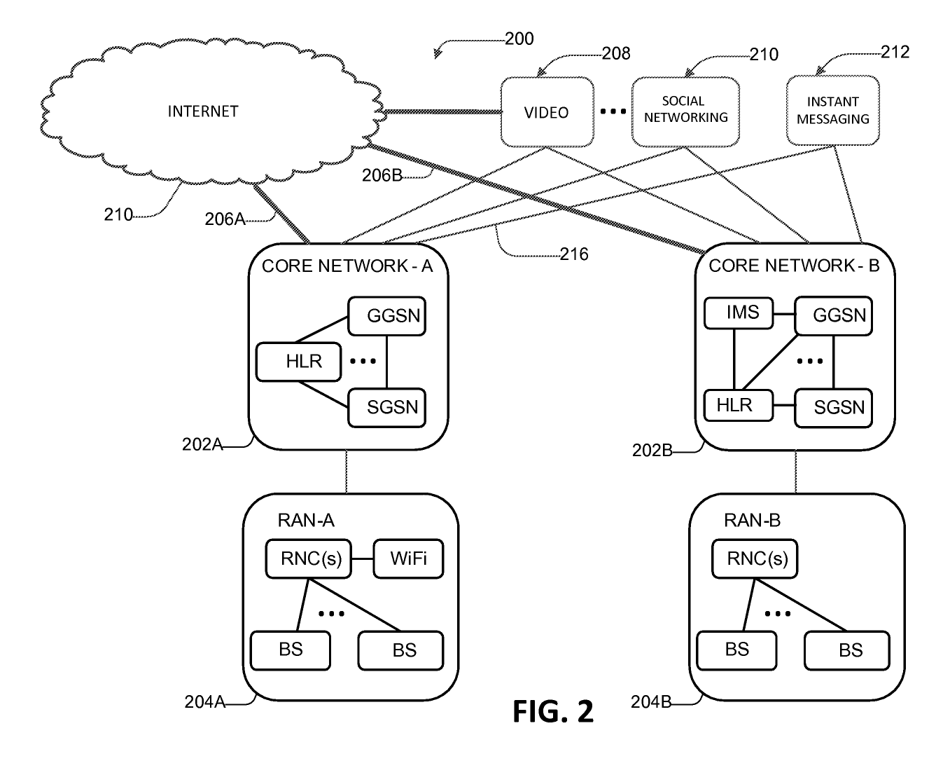

FIG. 2 illustrates an exemplary mobile network 200. The mobile network 200 may include, e.g., one or more core networks (CNs) and radio access networks (RANs). The MCN 200 may include one or more operators operating one or more CNs. For example, the operator A may operate CN-A, 202A, and the operator B may operate CN-B, 202B. Each of the CNs may be connected to one or more RANs, e.g., CN 202A may be connected to the RAN 204A, and CN 202B may be connected to RAN 204B. The CN-RAN combinations may have different configurations. For example, as illustrated in FIG. 2, RAN 204A may support a WiFi interface, whereas RAN 204B may not support such an interface. At the core network, operator B's CN, 202B may support IP Multimedia Subsystem (IMS) infrastructure, but Operator A's CN, 202A may not support such an infrastructure.

A MCN may be internet protocol (IP) based and may be connected to the internet (206A and 206B), e.g., for user traffic. The mobile networks but may be maintained as isolated (e.g., private) operator controlled networks (e.g., “walled garden”). The MCN may include added services, e.g., video 208, social networking 210, instant messaging 212, etc. The services may be part of the operator's network or may be provided by a third party service provider.

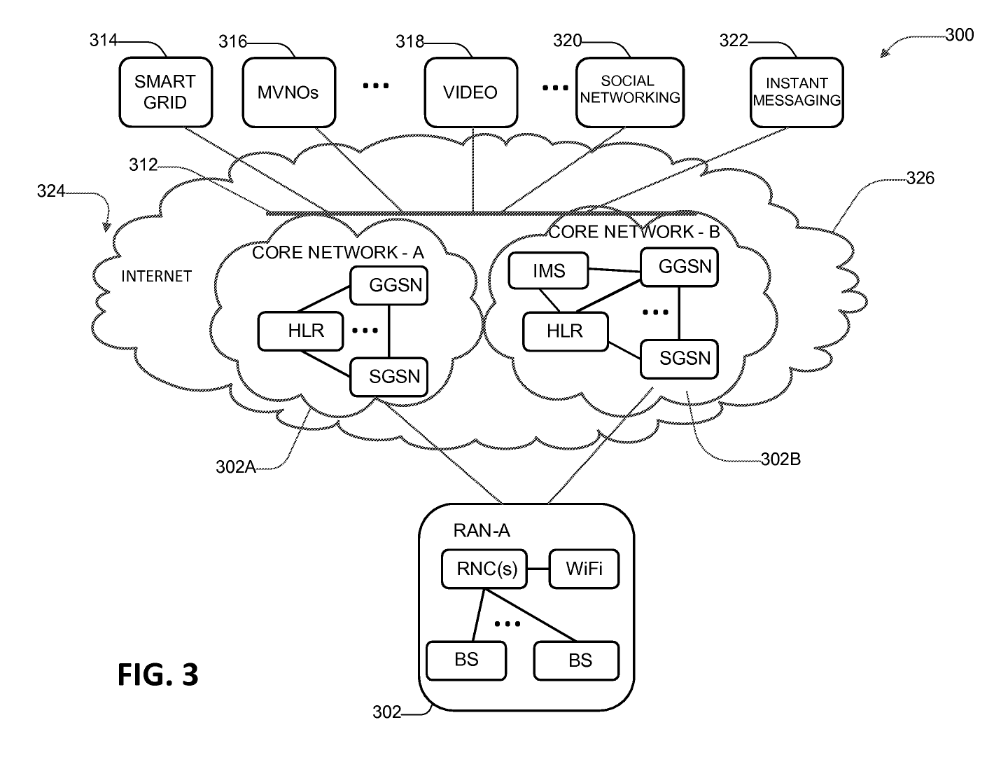

FIG. 3 illustrates an exemplary MCN 300, where the CNs 302A, and 302B may be virtualized and be part of the internet 326. The CNs integrated into the internet may be referred to generally as the mobile cloud 324. The mobile cloud may, e.g., establish “Network as a Service”. The operators of the CNs may maintain separate CNs (or, e.g., the CNs may be shared by the operators). The operators may have dedicated RANs or may share a RAN 304 as illustrated in FIG. 3. The individual CN nodes (e.g. HLR, SGSN) may be assigned public IP addresses and may send and/or receive IP packets with any other node in the Internet. One or more RAN nodes (e.g., the RNC node) may be moved into the mobile cloud 314 and may be assigned public IP address.

One or more service providers may communicate with the various CNs of the mobile cloud 324. The service providers may include, e.g., a smart grid operator, 314, a mobile virtual network operator (MVNO), 316, a video content provider, 318, a social networking provider, 320, a gaming provider, 322, etc.

The service providers may be independent of the mobile operator (e.g., “virtual” service providers). The service providers may access the CNs (e.g., CNs 302A, 302B) via, e.g., open network interface 312. The open network interface, 312 may be uniform across some or all operators, and may segregated, for example, into “bulk service” network interfaces and/or “per user” network interfaces.

The mobile network protocols (e.g., third generation partnership project (3GPP) mobility management, 3GPP call control, etc.) may run inside the mobile cloud 324. The mobile cloud architecture may allow for various configurations. The mobile cloud 324 may allow for on-demand service roll outs, where the operators and/or service providers may add or remove capacity by dynamically provisioning resources.

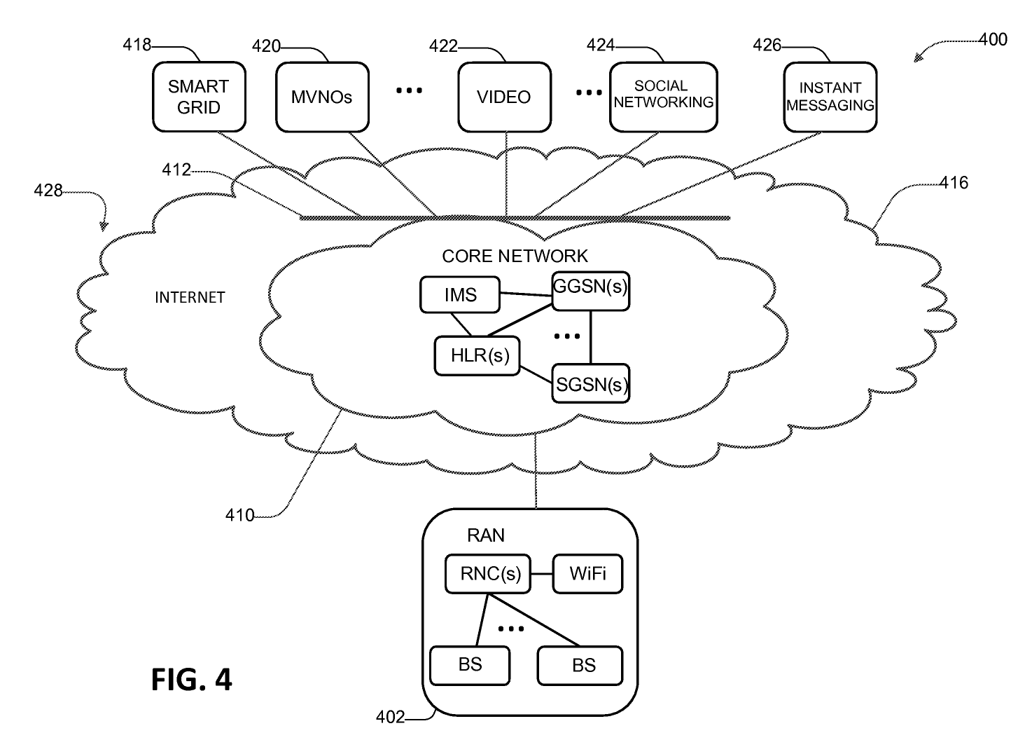

FIG. 4 illustrates exemplary mobile cloud architecture 400 where the CNs may be shared between operators to create, for example, a global mobile cloud 428. The global mobile cloud 428 may be formed, e.g., as a single mobile CN 410 that may stretch across the internet 416. A number of mobile CNs may form regional mobile clouds (e.g., European, Asian, North American etc. mobile clouds). The common mobile network interfaces 412 across the mobile operators and/or the mobile clouds may be segregated, for example, into “bulk service” network interfaces and/or “per user” network interfaces. A variety of service providers, for example, a smart grid operator, 418, a MVNO, 420, a video content provider 422, social networking providers 424, gaming providers 426, etc.

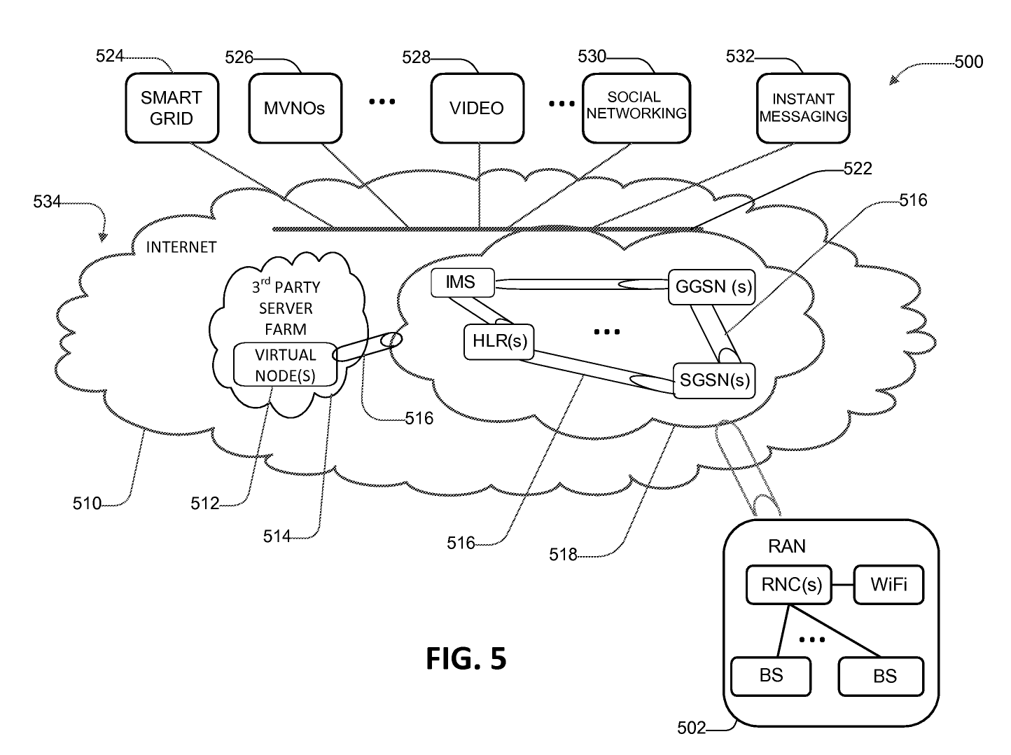

FIG. 5 illustrates an exemplary interconnection scheme 500 of a global mobile cloud 534. The mobile cloud may comprise one or more CNs 518 provided by one or more mobile operators. The CNs of mobile cloud may share one or more RANs, 502. The shared CN 518 may have public IP addresses. The nodes in the CN 518 (e.g., SGSN, GGSN, HLR, etc.) may be fully integrated. The nodes of the global CN 518 may be connected via secured tunnels 516. The tunnels 516 may run over the internet 510. The secured tunnels may be encrypted.

A variety of service providers may communicate with the CN 518 of the mobile cloud 534, e.g., via common network interfaces 522. The service providers may include, for example, a smart grid operator, 524, a MVNO 526, a video content provider 526, a social networking provider 530, a gaming provider, 532, etc.

The nodes in the mobile cloud 534 may be virtualized by adding virtual nodes 512. For example, the HLRs and/or SGSNs in the global mobile cloud 518 may dynamically provisioned (e.g., on demand) by the global mobile cloud 518 from, for example, Amazon EC2 and/or other 3^{rd} party cloud computing providers, 514. The network interfaces may allow for different types of network services, e.g., the “bulk service” network interfaces and/or the “per user slice” network interfaces.

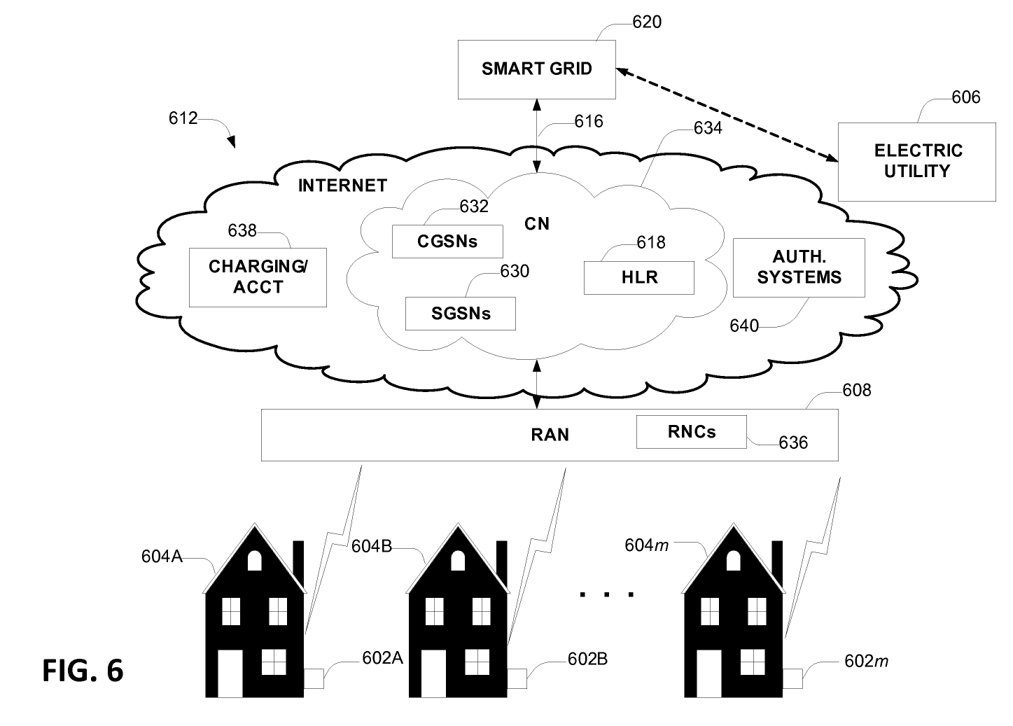

FIG. 6 illustrates an exemplary mobile network architecture that may enable a service provider, e.g., a smart grid operator to utilize a bulk portion of the mobile network capacity. In the illustrated architecture, mobile modems, e.g., 602A-m, may be installed at a number locations 604A-m. The electric utility 606 may access each of the 602A-m installations for smart grid services (e.g., to monitor the electric consumption rate and send certain control information to each location 604A-m). The electric utility smart grid application server 620 may formulate an electronic request to send to the network interface 616 of the mobile cloud 612. For example, the request may be sent via a mobile network API. The 602A-m installations may access the global mobile cloud 612 via a RAN 608. The smart grid application server 620 may trigger the network interface 616 by sending an IP message (e.g., a HTTP request) to a global mobile cloud HLR 618. The smart grid server 618 may determine the IP address of the HLR 618 by using a standard IP address resolution process like Domain Name System (DNS) lookup, for example.

Once the HLR 618 receives the request it may then process the request by communicating with other appropriate nodes in the global mobile cloud 612. For example, the HLR may first reserve capacity within itself to support a smart grid request. The HLR may communicate with SGSNs 630 and/or GGSNs 632 to receive processor capacity in the CN 634 for the smart grid modems 604A-m. The SGSNs 630 may communicate with the RNCs 636 to reserve RAN capacity for the smart grid locations 604A-m. In some cases, some of the RANs 608 may be integrated into the mobile cloud 612. If, for example, the SGSN 630 determines that it may not have enough capacity to handle the request, the SGSN 630 may dynamically request a third party server farm 552 to provide more SGSN capacity. The HLR 618 may communicate with a global mobile cloud charging and accounting systems 638 to inform them of the electronic banking information of the smart grid. The HLR may communicate with an authentication system 640 of the global mobile cloud 612 to provide it with the authentication keys of the smart grid locations 604A-m.

If the internal processing with the global mobile cloud 612 is successful, the HLR 618 may send back a successful HTTP Response to the smart grid application server 620 that sent the initial request. The smart grid server 620 may then send individual activation to each of modems 602A-m by sending a single multicast IP message directly to the appropriate global mobile cloud node (such as a multimedia broadcast multicast service (MBMS) broadcast server or some other IP multicast distribution mechanism). The MBMS or other IP multicast server may multicast this message through the global mobile cloud 612. The smart grid modems 602A-m may be pre-configured to start listening to this IP address so they may receive the message.

The cloud computing resources external to a mobile CN may be provisioned to perform one or more functions and/or processes. The cloud computing resources may perform such functions and/or processes on behalf of a CN entity, and may perform the functions and/or processes in lieu of or in addition to the CN entity. The functions and/or processes may be migrated to the cloud computing resources. One or more of the sessions associated with the functions and/or processes running on the CN entity may be migrated.

The CN entity may provide to the cloud computing resources information for causing the cloud computing resources to undergo provisioning and/or for causing operation of the provisioned cloud computing resources. The CN entity and the cloud computing resources may negotiate (e.g., by way of exchanging messages) the provisioning and/or execution of the provisioned cloud computing resources on an ad hoc basis. Provisioning of the cloud computing resources and/or operation of the provisioned cloud computing resources may be carried out on a temporary basis.

The provisioned cloud computing resources may remain provisioned and be available for execution for more than a temporary basis (e.g., a semi-permanently and/or permanently basis). The provisioned cloud computing resources may be executed on demand without having to acquire cloud computing resources and to repeat provisioning of such cloud computing resources. Updates, modifications and/or other changes to the provisioning may be carried out, in some instances, without acquiring more cloud computing resources than previously acquired. In other instances, the updates, modifications and/or other changes to the provisioning may result in acquiring additional cloud computing resources.

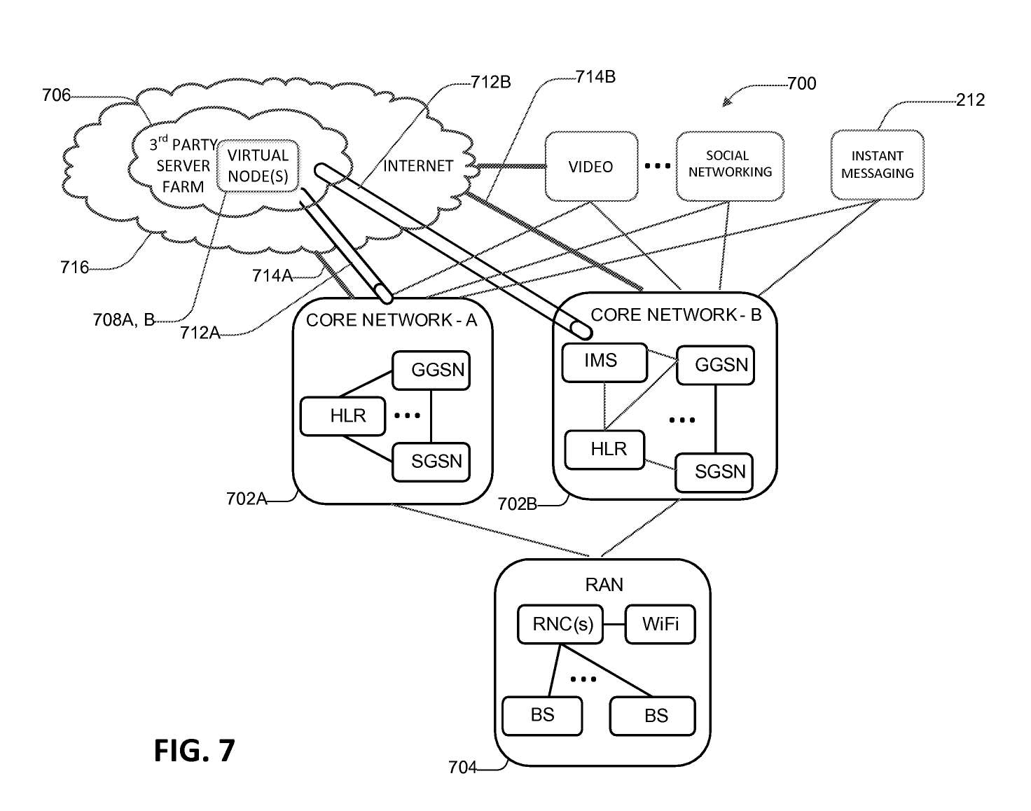

FIG. 7 illustrates an exemplary architecture of a hybrid mobile network 700. The hybrid mobile network 700 may be used for performing mobile cloud bursting. The hybrid mobile network 700 may include network elements, for example, a CN-A, 702A, a CN-B, 702B and RAN, 704. Each of core networks and/or the access network may be maintained as a private walled garden network. For example, Operator A may operate CN 702A, operator B may operate CN 702B, and the RAN 704 may be shared by the core networks 702A, and 702B. The CNs may have different configurations. For example, Operator B's CN 702B may supports an IMS infrastructure, whereas the Operator A's CN 702A may not.

The mobile network (e.g., hybrid mobile network 700) may include, for example, third-party cloud servers 706. The third-party cloud servers may be part of a secondary public network. For example, the third-party cloud servers may include Google, Amazon EC2, Microsoft Azure, etc. The third-party cloud servers 706 may include one or more virtual nodes, e.g., 708A, 708B. The virtual nodes may be disposed external to the walled gardens of the mobile network, including the core networks, e.g., CN 702A and CN 702B. The virtual nodes may appear indistinguishable from other CN nodes and/or functions. The virtual nodes 708A, 708B may appear as part of the walled gardens nodes of the CN 702A and CN 702B.

The virtual nodes, e.g., 708A, 708B may be formed (e.g., dynamically) responsive to the third-party cloud servers 706 (e.g., cloud computing resources) being provisioned to perform functions and/or processes of a CN entity, e.g., an IMS, 710. The virtual nodes may result from provisioning the third-party cloud servers 706 to provide, for example, additional processing capacity. The virtual nodes may be couple with the CNs 702A and 702B, respectively, e.g., via communication links through the internet 716. The communication links may include, for example, encrypted IP tunnels 712A, 712B. In addition to the IP tunnels 712A, 712B, connections 714A and 714B may be used to carry user traffic between the CN 702A and CN 702B and the internet 716.

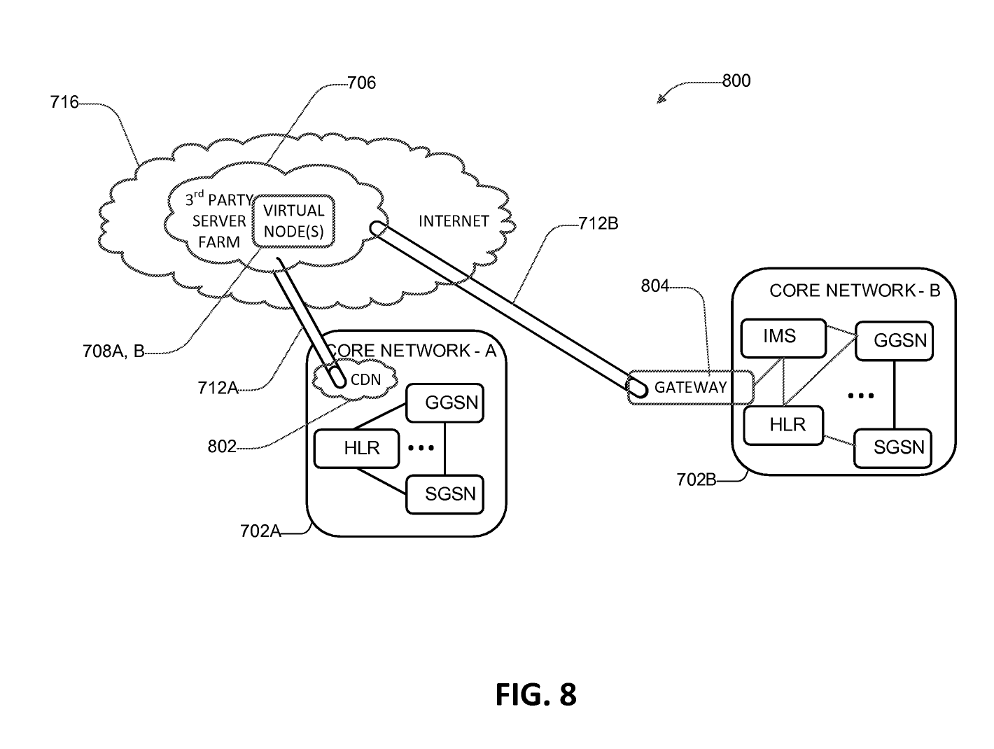

FIG. 8 illustrates an exemplary system diagram of interconnection scheme 800 for a hybrid mobile network, such as the hybrid mobile network 700 of FIG. 7. The CNs may be interconnected to the third-party cloud servers 706 in a number of ways. For example, a direct communication between CN node 702A and the third-party cloud servers 706 may be established, e.g., between CDN 802 of the CN 702A and a virtual node 708A. The relevant CN nodes (e.g., CDN 802) may be assigned public IP address, and may be adapted to support (e.g., messaging) interaction with the third-party cloud servers 706. As illustrated in FIG. 8, a CN may include a gateway 804 to provide an interface between the CNs and the third-party cloud servers 706, as shown. The gateway 804 may be adapted, for example, to perform signaling, address conversions, protocol conversions to facilitate communicate with the third-party cloud servers 706.

A core network, for example, may detect a condition related to a mobile network computing resource (MNCR). Based on the detection of the condition, a request (e.g., cloud computing resource (CCR) request) may be generated. The CCR request may be transmitted to a cloud server (e.g., a third-party cloud server and/or provider). For example, the request may be sent directly or via a gateway to the cloud server. The cloud server, if capable to provide the MNCR, may send to the CN an indication of an acknowledgement and/or approval for obtaining the requested cloud computing resource. The CN entity may send a provisioning request including, e.g., “provisioning information” for provisioning the CCR for one or more services that may be offered to a subscriber of the CN. The CN provisioning request may send, to the CCR, a message to download the provisioning information. The CN entity may push the provisioning information to the CCR.

The cloud servers (e.g., third party servers) may undergo provisioning of the allocated CCRs to form virtual node(s). The virtual nodes (e.g., provisioned CCRs) may execute functions for carrying out the services. The CN entity may redirect service requests from the CN to the virtual node(s). The CN entity may redirect one or more requests to the virtual node(s). The CN entity may move one or more ongoing sessions from the CN to the virtual node(s) provisioned to provide the services. In one or more embodiments, after moving the ongoing sessions from the CN entity servicing such sessions, such CN entity may be shut down and/or deactivated.

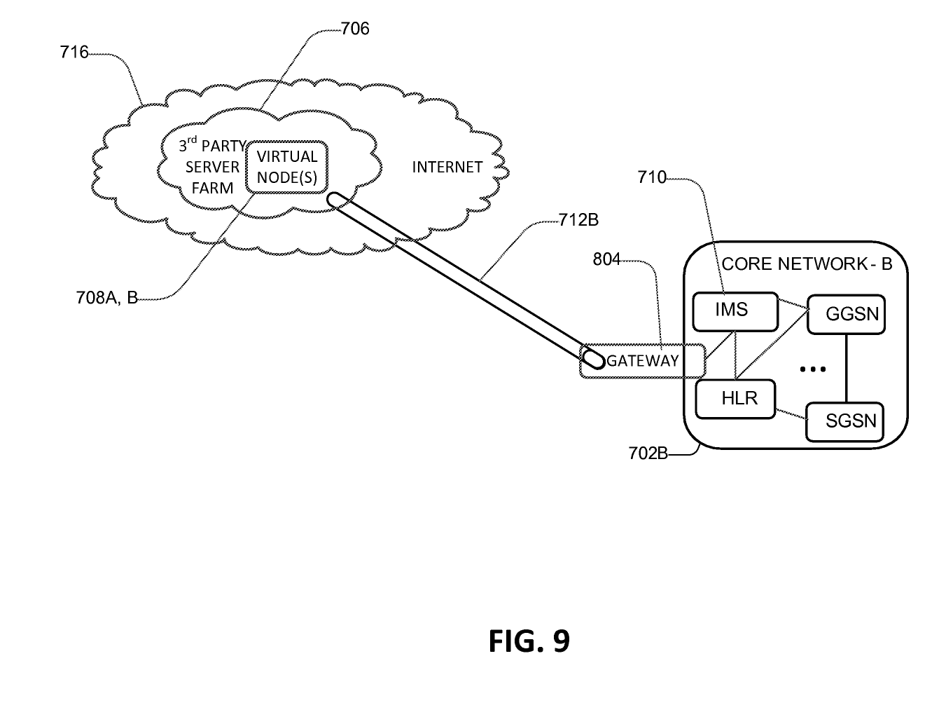

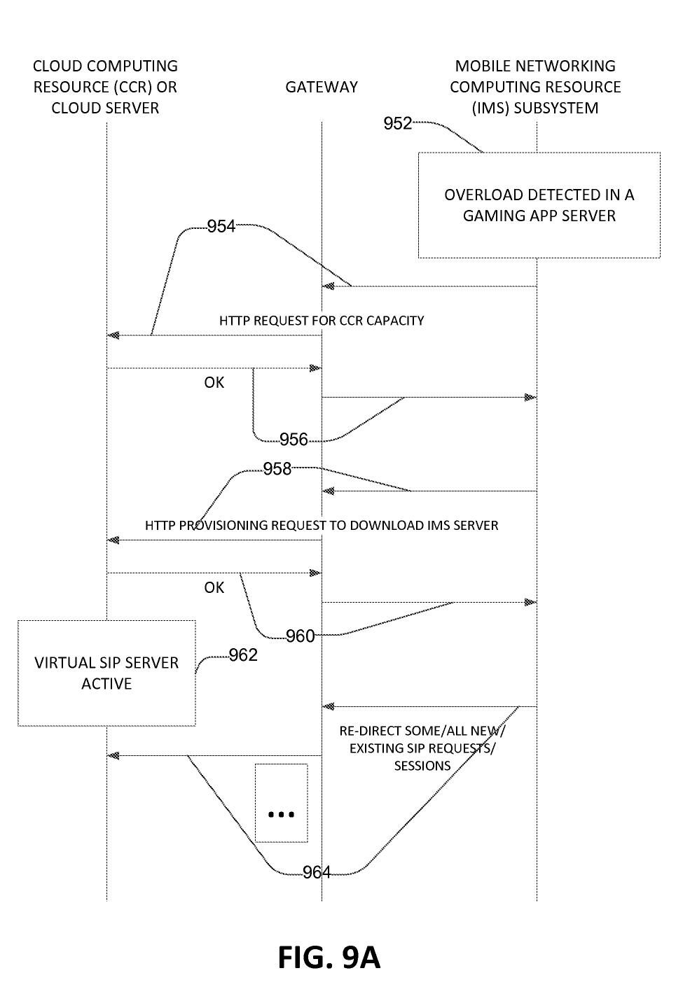

FIG. 9 illustrates an exemplary architecture and interconnection scheme of a hybrid mobile network 900 (e.g., a portion of hybrid mobile network 700 and 800). FIG. 9A illustrates an exemplary flow chart 950 for performing mobile network cloud bursting of a mobile networking computing resource (MNCR) (e.g., an IMS application) experiencing a condition (e.g., an overload condition). The flow chart 950 may include signaling and/or processes for performing the mobile network cloud bursting of the MNCR based on the detection of the overload condition. The MNCR, e.g., the IMS application may be a gaming application.

As illustrated by example in FIG. 9, the mobile operator of the CN 702B may have one or more IMS (SIP) application servers in the walled garden of the CN 702B, e.g., for a gaming service, the mobile network operator may be offering to its subscribers. The gaming service and the IMS application servers may run out of capacity. The mobile operator may use the mobile network cloud bursting to address the capacity issue.

The IMS server (e.g., a green walled IMS server) 710 running the IMS application in the walled garden of CN 702B may detect a condition (e.g., an overload condition) 952. The detection of the overload condition may be based on, for example, an indication that the IMS server 710 approaching peak capacity, e.g., due to allocations for the gaming service. The IMS server 710 may send, e.g., via the gateway 804, to the provider of the third-party cloud servers 706, a provisioning request 954 for CCRs that may be provisioned for the SIP gaming service, and provide the desired additional capacity. For example, the provisioning request 954 may be a Hypertext Transfer Protocol (HTTP) request message. In response to the provisioning request e.g., via the gateway 804, the IMS server may receive, from the third party cloud servers 706, an acknowledgement message 956. The acknowledgement message may include an indication of an acknowledgement and/or approval for the requested CCRs 954.

The gateway 804 may then setup a secure IP tunnel 712B to third-party cloud servers, for communications between the IMS server 710 and the third-party cloud servers 706. In some cases, the IP tunnel may be provisioned in advance. The IMS server 710 may exchange provisioning request messages with the third-party cloud servers 706, via the gateway 804, to cause a download of a SIP application server image to the third-party cloud servers 706. The IMS server 710 may send a HTTP provisioning request message, via the gateway 804, to request 958 the third-party cloud servers 706 to download the SIP application server image. The third-party cloud servers 706 may send to the IMS server 710 an acknowledgement message 960 to the provisioning request message. The third-party cloud servers 706 may download the SIP application server image. Using the downloaded SIP application server image, one or more of the third-party cloud servers 706 may be provisioned to form the virtual node 708B. The virtual node may execute the SIP application server and become active 962.

The IMS server 710 may send message (e.g., session initiation protocol (SIP) message) redirects 964 for new gaming requests and/or may move sessions to the virtual node 708B (or other of the third-party cloud servers 706). The redirects for the new gaming requests and/or sessions to the virtual node 708B may occur, for example, for duration of a peak traffic period. The IMS server 710 may be adapted with IMS procedures and protocols (e.g., to generate HTTP requests to the gateway 804) in the network. The request, response, and/or redirect messages may be carried out in real time and/or using real-time processing. The request, response, and/or redirect messages may be sent over the tunnel 712B.

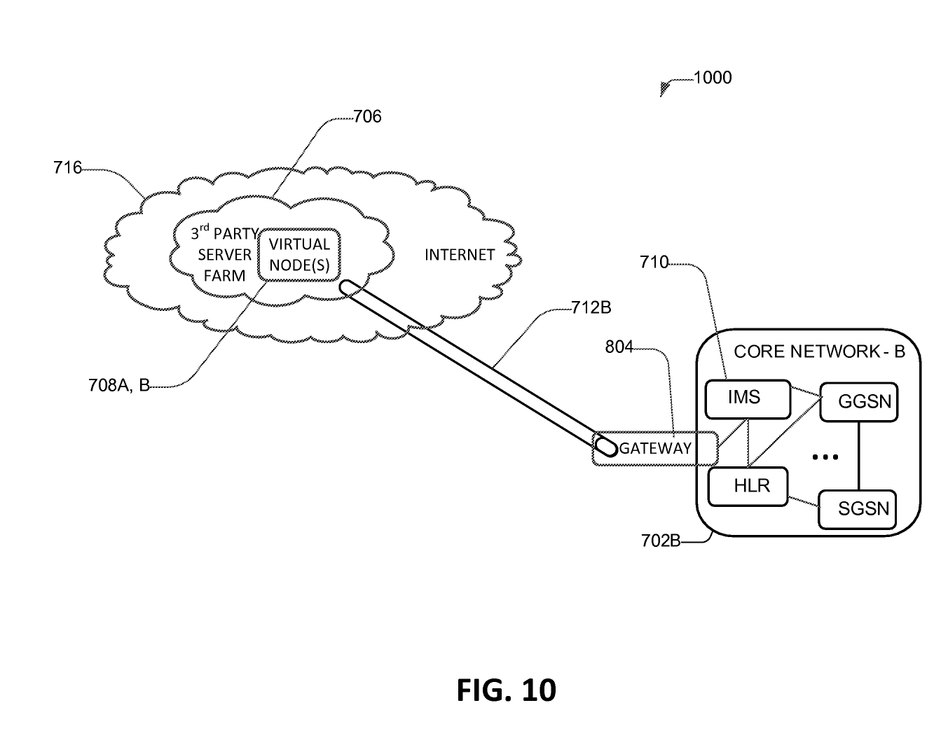

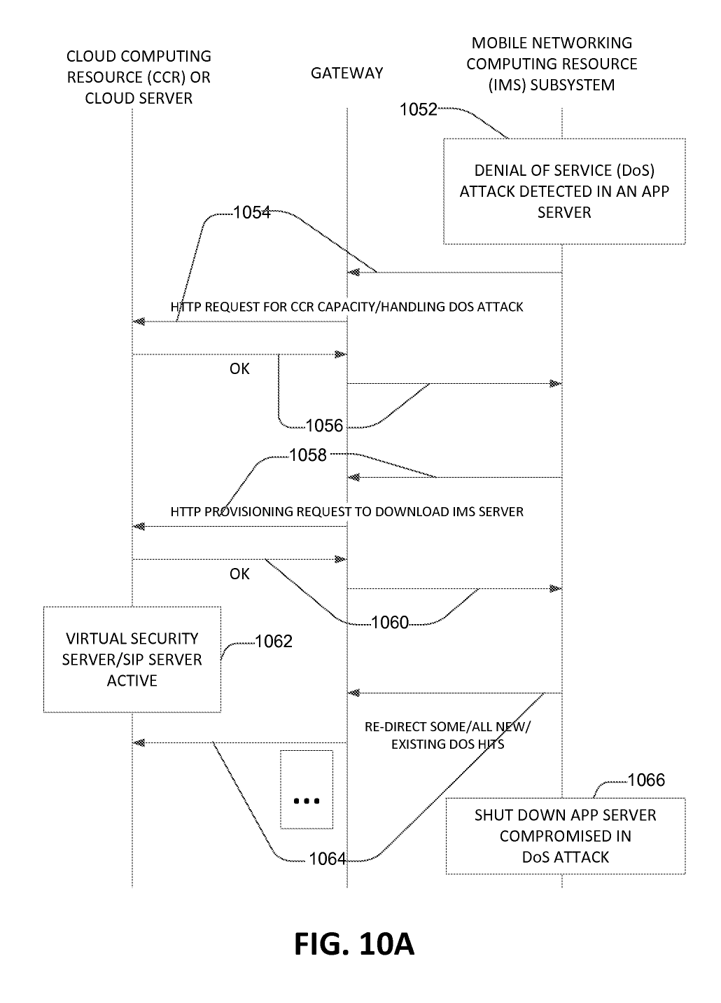

FIG. 10 illustrates an exemplary architecture and interconnection scheme of a hybrid mobile network 1000 (e.g., a portion of hybrid mobile network 700 and 800). FIG. 10A illustrates an exemplary flow chart 1050 for performing mobile network cloud bursting, e.g., to handle a DoS attack of an IMS application. The flow chart 1050 may include signaling and/or processes for performing the mobile network cloud bursting for the MNCR handling the DoS attack of the IMS application. The mobile network cloud bursting illustrated by example in flow chart 1050 may be used for a DoS attack of a non-IMS node, e.g., SGSN, GGSN, etc.

The operator and/or an entity of the CN 702B may, for example, detect that an application that may cause security problems in its CN 702B. The operator and/or the CN entity of the CN 702B may migrate (e.g., temporarily) the functions/processes of the given application to a MNCR, e.g., a third party cloud server 706.

The IMS server 710 running the IMS application in the walled garden of CN 702B, e.g., may detect a condition (e.g., a denial of service (DoS) attack) 1052. The IMS server 710 may send, e.g., via the gateway 804, to the provider of the third-party cloud servers 706, a provisioning request 1054 for CCRs that may be provisioned, e.g., to handle the DoS attack and/or the SIP gaming service. For example, the provisioning request 1054 may be a Hypertext Transfer Protocol (HTTP) request message. In response to the provisioning request e.g., via the gateway 804, the IMS server may receive, from the third party cloud servers 706, an acknowledgement message 1056. The acknowledgement message may include an indication of an acknowledgement and/or approval for the requested CCR 954.

The gateway 804 may then setup a secure IP tunnel 712B to third-party cloud servers for communications between the IMS server 710 and the third-party cloud servers 706. In some cases, the IP tunnel may be provisioned in advance. The IMS server 710 may exchange provisioning request messages with the third-party cloud servers 706, via the gateway 804, to cause a download of a SIP application server image to the third-party cloud servers 706. The IMS server 710 may send a HTTP provisioning request message 1058, via the gateway 804, to request the third-party cloud servers 706, e.g., to download the SIP application server image, and/or activate a security service on the third party cloud servers. In response to the provisioning request e.g., via the gateway 804, the IMS server may receive, an acknowledgement message 1060. The third-party cloud servers 706 may download the SIP application server image. Using the downloaded SIP application server image, one or more of the third-party cloud servers 706 may be provisioned to form the virtual node 708B. The virtual node may execute the SIP application server and become active 962. The third-party cloud servers 706 may be configured with security features that may allow for handling of the traffic moved to the virtual node 708B.

The IMS server 710 may send message (e.g., SIP message) redirects 964 for new gaming requests and/or may move the sessions to the virtual node 708B. The IMS server 710 may send redirect the new requests and/or move the sessions to the virtual node 708B. The IMS 710 may shutdown and/or deactivate the application service(s) compromised in the DoS attack.

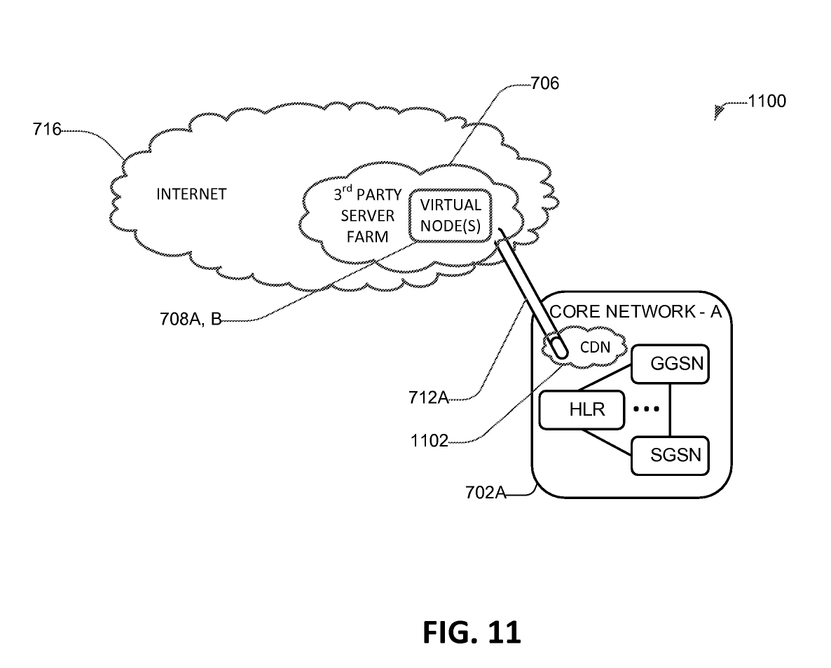

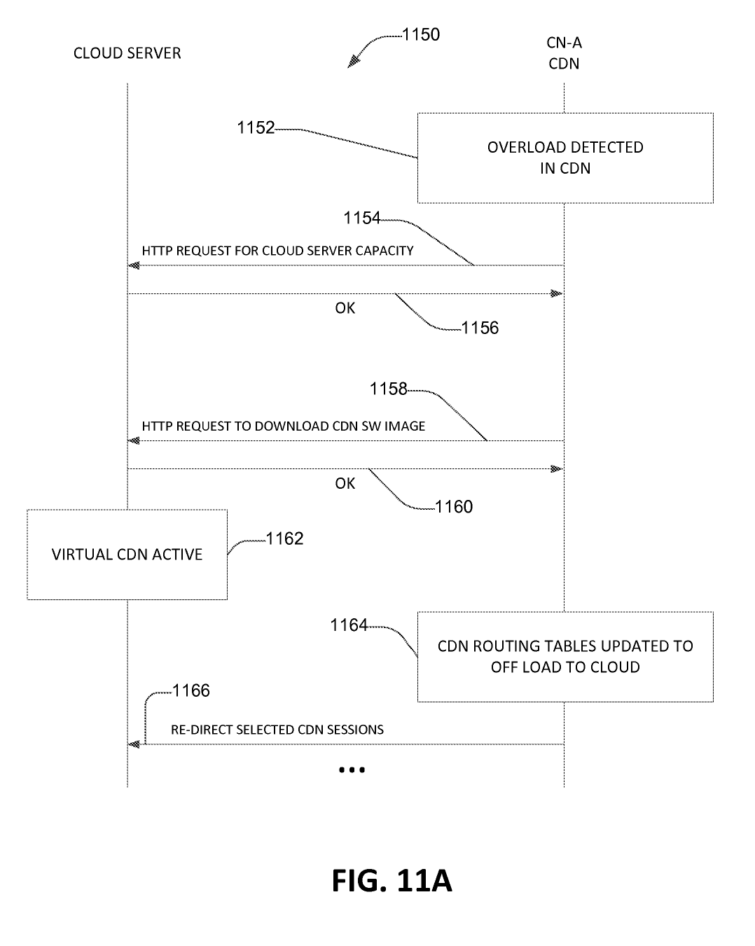

FIG. 11 illustrates an exemplary architecture and interconnection scheme of a hybrid mobile network 1100 (e.g., a portion of hybrid mobile network 700 and 800). FIG. 11A illustrates an exemplary flow chart 1150 for performing mobile network cloud bursting of a mobile networking computing resource (MNCR) experiencing a condition (e.g., a content distribution network (CDN) overload). The CDN may perform caching and/or transcoding of streaming content. The flow chart 1150 may include signaling and/or processes for performing the mobile network cloud bursting of CN entities under overload conditions.

A mobile operator, e.g., operator A of the CN 702A may have one more servers deployed that may form the CDN 1102 in the walled garden of the CN 702A for caching content. The mobile operator may perform transcoding of the content in several formats, e.g., based on screen size, format and capabilities of various devices supported by the network. When demand for the content exceeds such that the CDN may not be able to accommodate the exceeding demand, the mobile operator may invoke mobile network cloud bursting to alleviate the capacity issues.

As illustrated by example in FIG. 11, the CN entity of the CN 702A (e.g., one of the CDN servers) may detect a condition (e.g., a CDN overload condition) 1152. The detection of the overload condition of the CDN servers. For example, the CDN servers may approach peak capacity. The CN entity of the CN 702A may initiate and send to the provider of the third-party cloud servers 706 a CCR request 1154 for CCRs that may be provisioned for computing power, and/or storage resources. The CCR request may be a HTTP request message. The third-party cloud servers 706, in response, may send and acknowledgment message 1156, including, for example, an indication of an acknowledgement and/or approval of the CCR request. An IP tunnel (e.g., a secured IP tunnel) may be established between the CN entity of the CN 702A and the third party cloud servers 706. The IP tunnel may be provisioned in advance.

The CN entity of the CN 702A may exchange messages with the third-party cloud servers 706 so as to cause downloading of software to handle content operations such caching, transcoding, and trans-rating into the third-party cloud servers 706. In an embodiment, the CN entity of the CN 702A may send a HTTP request message 1158 to request the third-party cloud servers 706 to download the software. In response to the provisioning request e.g., via the gateway 804, the IMS server may receive an acknowledgement 1160 to the request to download the software. The third-party cloud servers 706 may download the software. Using the downloaded software, one or more of the third-party cloud servers 706 may undergo provisioning to form the virtual node 708A, which, in turn, may execute the software and become active (1162). When the virtual node 708A is active, the CDN routing tables associated with the CDN 802 may be updated, 1164 to reflect offloading to the virtual node 708A (e.g., provisioned CCRs).

The IMS server 710 may send (e.g., SIP) message redirects 1064 for new gaming requests and/or may move sessions to the virtual node 708B (or other of the third-party cloud servers 706). The redirects for the new CDN requests and/or sessions to the virtual node 708B may occur, for example, for duration of a peak traffic period. The CN entity of the CN 702A may be adapted with procedures and protocols (e.g., to generate HTTP/SIP requests and/or other messages) in the network. The request, response, and/or redirect messages may be carried out in real time and/or using real-time processing.

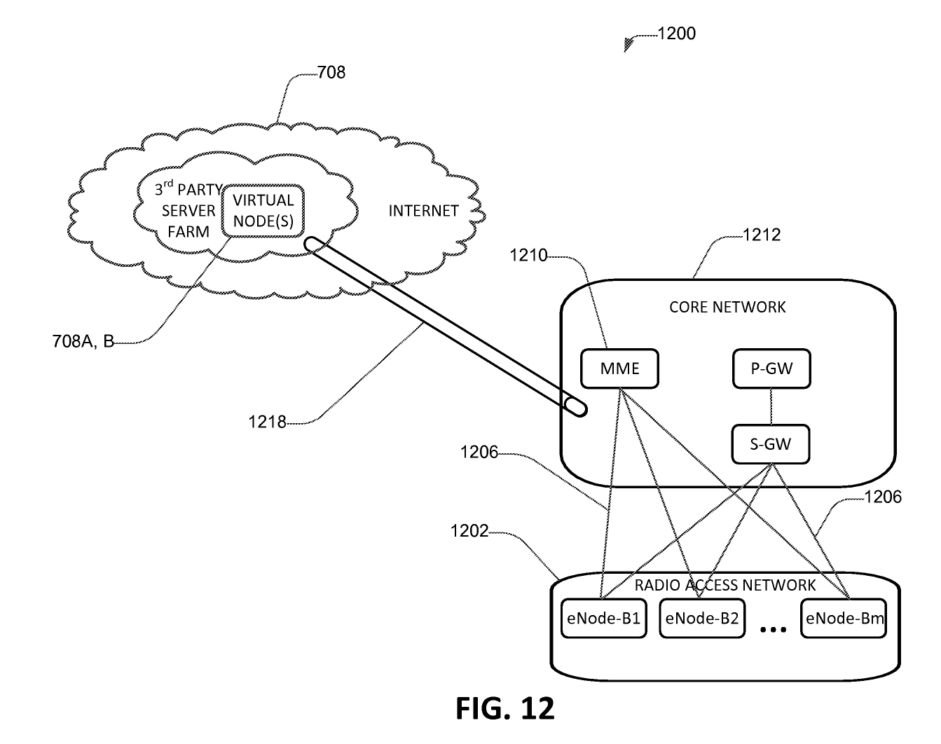

FIG. 12 illustrates an exemplary architecture and interconnection scheme of a hybrid mobile network 1200. As illustrated in FIG. 12, the underlying mobile network, for example, may be a long term evolution (LTE) or advanced long term evolution LTE-A network. In the exemplary architecture of FIG. 12, the core network 1212 may be connected to a RAN 1202, e.g., via S1 interfaces 1206.

A mobile operator, e.g., operator A of the CN 1212 may have one more servers deployed that may provide a service in the walled garden of the CN 1212. When demand for a computing resource exceeds such that the CDN may not be able to accommodate the exceeding demand, the mobile operator may invoke mobile network cloud bursting to alleviate the issue.

As illustrated by example in FIG. 12, a CN entity of the CN 1212 may detect an overload condition. Based on the detected overload condition, the CN entity of the CN 1212 may initiate and send to the provider of the third-party cloud servers 708 a CCR request for CCRs that may be provisioned for computing power, and/or storage resources. The third-party cloud servers 708, in response, may send and acknowledgment message, including, for example, an indication of an acknowledgement and/or approval of the CCR request. An IP tunnel 1218 (e.g., a secure communication tunnel) may be established between the CN entity of the CN 1212 and the third-party cloud servers 708. In some cases, the IP tunnel may be provisioned in advance.

The CN entity of the CN 1212 may exchange messages (e.g., HTTP messages) with the third-party cloud servers 708. The third-party cloud servers 706 may download the software. Using the downloaded software, one or more of the third-party cloud servers 706 may undergo provisioning to form the virtual node 708A, which, in turn, may execute the software and become active. The core network may redirect its current and/or future service requests and/or sessions onto the activated CCRs.

A mobile operator, using a centralized command, may track the management of operations. The addition of the CCR may be a virtualized extension of the CN 702A. Depending on traffic for the content, the mobile operator may increase or decrease the load for content handling operations on third-party cloud servers 706. The load increase or decrease may be performed in real-time.

A mobile network operator may choose to uninstall the software duplicated during the mobile network cloud bursting operations. The CCR providers may keep the software to accelerate the application bursting performance for subsequent content management migration scenarios.

To enable cloud bursting for mobile networks, the CNs (and entities thereof) of mobile networks may be adapted to provide operations, for example, to start, pause, resume and/or stop the mobile network cloud bursting functionality.

Various exemplary architectures, signaling and/or processing steps for performing mobile network cloud bursting, e.g., for IMS Application servers overload, security and CDN overload are described herein. One of ordinary skill in the art will appreciate that the mobile network cloud bursting concepts disclosed herein may be applicable to other applications and scenarios.

After offloading the extra traffic, the mobile operator may inquire for statistics from the provider of the CCR (e.g., third-party cloud servers) 706. The statistical information may include, for example, the usage of computing resources (e.g., CPU, memory, storage, bandwidth, etc.) by the CCR. The mobile operator may obtain data, e.g., to handle future mobile network cloud bursting.

Using the mobile network cloud bursting provided herein, a network operator may effectively scale its mobile networking resources by bursting to the cloud resources. The network operator may be able to distribute network traffic to walled-garden mobile cloud or to other provider(s) of third-party cloud servers. The mobile network cloud bursting may allow the mobile network operators to partition traffic between private and/or public hybrid cloud systems. Mobile network cloud bursting operations may be based on one or more policy factors, e.g., price, business relations etc. Such policy decisions may be driven, for example, by a policy and charging rules function (PCRF) or PCRF-like policy and changing control (PCC) entity within a 3GPP mobile CN.

Although features and elements described herein address the mobile network cloud bursting, e.g., between a mobile operator network (e.g., CN) and third-party cloud server 706, one of ordinary skill in the art will appreciated that each feature and/or element may be used between two different mobile operators. One of ordinary skill in the art will appreciated the elements and feature disclosed herein may be applied to mobile networks (e.g., a LTE/LTE-A network for a MNO or a data center operator running mobile CN nodes in a data center).

One of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, WTRU, terminal, base station, RNC, or any host computer.

1-34. (canceled)

35. A method of managing a mobile networking computing resource (MNCR) in a mobile network (MN), the method comprising:
detecting a condition related to the MNCR at a node in the MN;
generating, based on the condition, a cloud computing resource (CCR) request; and
transmitting the generated CCR request to a secondary network (SN), wherein the SN is external to the MN.

36. The method of claim 35, comprising generating a provisioning request and transmitting the provisioning request, wherein the provisioning request comprises an instruction to configure a CCR.

37. The method of claim 35, re-directing an existing session or a request to establish new sessions to a CCR.

38. The method of claim 35, comprising establishing a secure communication channel between the MNCR and a CCR.

39. The method of claim 35, wherein transmitting the CCR request comprises transmitting the CCR request, via a tunnel, wherein the tunnel is a secure internet protocol (IP) tunnel.

40. The method of claim 35, wherein sending the CCR request comprises sending the CCR request via a gateway node.

41. The method of claim 36, wherein the provisioning request comprises a software download request.

42. The method of claim 36, wherein sending the provisioning request, comprises sending the provisioning request, via a tunnel, wherein the tunnel is a secure internet protocol (IP) tunnel.

43. The method of claim 36, wherein sending the provisioning request comprises sending the provisioning request via a gateway node.

44. The method of claim 36, wherein the MNCR is part of a private network and the CCR is part of a public network.

45. The method of claim 35, wherein the condition comprises one of a MNCR overload, a content delivery network (CDN) overload, or a MNCR security threat.

46. A core network (CN) entity of a mobile networking entity configured to manage a mobile networking computing resource (MNCR), the mobile networking entity comprising:
a processor configured to:
detect a condition related to the MNCR at a node in the MN;
generate, based on the condition, a cloud computing resource (CCR) request; and
transmit the CCR request to a secondary network (SN), wherein the SN is external to the MN.

47. The CN entity of claim 46, wherein the processor is configured to generate a provisioning request, wherein the provisioning request comprises an instruction to configure a CCR, and transmitting the provisioning request.

48. The CN entity of claim 46, wherein the processor is configured to re-direct an existing session or a request to establish new sessions to a CCR.

49. The CN entity of claim 46, wherein the processor is configured to establish a secure communication channel between the MNCR and a CCR.

50. The CN entity of claim 46, wherein transmitting the CCR request comprises transmitting the CCR request, via a tunnel, wherein the tunnel is a secure internet protocol (IP) tunnel.

51. The CN entity of claim 46, wherein sending the CCR request comprises sending the CCR request via a gateway node.

52. The CN entity of claim 47, wherein the provisioning request comprises a software download request.

53. The CN entity of claim 47, wherein sending the provisioning request, comprises sending the provisioning request, via a tunnel, wherein the tunnel is a secure internet protocol (IP) tunnel.

54. The CN entity of claim 47, wherein sending the provisioning request comprises sending the provisioning request via a gateway node.

55. The CN entity of claim 47, wherein the MNCR is part of a private network and the CCR is part of a public network.

56. The CN entity of claim 46, wherein the condition comprises one of a MNCR overload, a content delivery network (CDN) overload, or a MNCR security threat.
